(19) United States
(12) Patent Application Publication
(10) Pub. No.: US 2012/0325511 A1
(43) Pub. Date: Dec. 27, 2012

(54) AIR-INLET SWITCHING ASSEMBLY FOR A PNEUMATIC TOOL

(76) Inventor: Ming-Ta Cheng, Taichung City (TW)

(21) Appl. No.: 13/165,179

(22) Filed: Jun. 21, 2011

(51) Int. Cl. B23B 45/04

(52) U.S. Cl. 173/169

(57) ABSTRACT

An air-inlet switching assembly for a pneumatic tool having a gun shaped shell and a cylinder, the air-inlet switching assembly is mounted in the shell below the cylinder and has a selector valve and a switching stem. The selector valve is rotatably mounted in an inlet tube of the shell below the cylinder, selectively communicates one of the passageways of the cylinder and has a clamping protrusion and a valve seat. The clamping protrusion is formed eccentrically on and protrudes from the external surface of the selector valve. The valve seat is formed on and protrudes upward from a top of the selector valve and has a valve hole selectively communicating with one of the passageways of the cylinder. The switching stem is movably mounted in the shell, is connected securely to the selector valve and has a clamping arm connected securely to the clamping protrusion of the selector valve.

### BACKGROUND OF THE INVENTION

1. Field of the Invention

The present invention relates to an air-inlet switching assembly, and more particularly to an air-inlet switching assembly for a pneumatic tool that can be operated, assembled and maintained conveniently and can reduce the cost of production.

2. Description of Related Art

In general, conventional pneumatic tools are used to fasten or loosen bolts or nuts by driving and controlling the flow direction of compressed air in the conventional pneumatic tools.

A conventional pneumatic tool disclosed in U.S. Pat. No. 5,199,460 has an air-inlet switching assembly mounted in a shell of the conventional pneumatic tool to control the flow direction of the compressed air. The conventional air-inlet switching assembly has a selector valve and two pressing stems. The selector valve is mounted in the shell, selectively communicates with one of the air channels of a cylinder of the conventional pneumatic tool and has an external surface and multiple engaging teeth. The engaging teeth are formed on and protrude from the external surface of the selector valve. The pressing stems are movably connected to the shell of the conventional pneumatic tool and engage the selector valve, and each pressing stem has an inner end, an outer end, a sidewall and multiple engaging teeth. The inner ends of the pressing stems are movably mounted in the shell beside the selector valve to enable the sidewalls of the pressing stem to face the engaging teeth of the selector valve. The outer ends of the pressing stems extend out of a rear side of the shell. The engaging teeth are formed on and protrude from the sidewalls of the pressing stems and engage the engaging teeth of the selector valve.

The conventional pneumatic tool can control the flow direction of the compressed air by pushing the outer ends of the pressing stems to rotate the selector valve relative to the cylinder and to communicate the selector valve with one of the air channels of the cylinder. However, the engaging teeth between the selector valve and the pressing stems may wear downs after a long time and cannot be used to rotate the selector valve accurately communicating one of the air channels of the cylinder, and this will influence the operation of the conventional pneumatic tool.

In addition, another air-inlet switching assembly of a conventional pneumatic tool disclosed in US Publication No. 2008/0066941 A1 has a pushing shaft, a linking shaft, a first vale member and a second valve member. The pushing shaft is movably and transversely mounted in a shell of the conventional pneumatic tool near a handle of the conventional pneumatic tool and has two outer ends extending out of the shell. The linking shaft is connected to the pushing shaft, is mounted in the shell and extends backward to a rear of the shell. The first valve member is connected to the linking shaft opposite to the pushing shaft. The second valve member is mounted securely in the shell, is mounted around the first valve member and communicates with the air channels of a cylinder of the conventional pneumatic tool.

The conventional pneumatic tool that disclosed in US Publication No. 2008/0066941 A1 can control the flow direction of the compressed air by pushing one of the outer ends of the pressing shaft to rotate the first valve member relative to the second valve member and to enable the compressed air to flow in the cylinder via the second valve member and a corresponding air channel. However, the conventional pneumatic tool has multiple components, and this will increase the cost for manufacturing the air-inlet switching assembly and the difficulty of assembling the air-inlet switching assembly.

Additionally, another conventional air-inlet switching assembly of a conventional pneumatic tool disclosed in Taiwan Patent No. 1319346 has a control stem, a rotating tube and a selector valve. The control stem is movably and transversely mounted in a shell of the conventional pneumatic tool near a handle of the conventional pneumatic tool and has two outer ends extending out of the shell. The rotating tube is connected securely to the control stem and is mounted rotatably in the shell. The selector valve is mounted in the shell, is mounted around the rotating tube and communicates with the air channels of a cylinder of the conventional pneumatic tool.

The conventional pneumatic tool can control the flow direction of the compressed air by pushing the control stem to rotate the rotating tube relative to the selector valve and to enable the compressed air to flow in the cylinder via the selector valve and a corresponding air channel. However, the conventional pneumatic tool has multiple components, and this will increase the cost for manufacturing the air-inlet switching assembly and the difficulty of assembling the air-inlet switching assembly.

The air-inlet switching assembly for a pneumatic tool in accordance with the present invention mitigates or obviates the aforementioned problems.

### SUMMARY OF THE INVENTION

The main objective of the present invention is to provide an air-inlet switching assembly for a pneumatic tool that can be operated, assembled and maintained conveniently and can reduce the cost of production.

The air-inlet switching assembly in accordance with the present invention for a pneumatic tool having a gun shaped shell and a cylinder, and the air-inlet switching assembly is mounted in the shell below the cylinder and has a selector valve and a switching stem. The selector valve is rotatably mounted in an inlet tube of the shell below the cylinder, selectively communicates one of the passageways of the cylinder and has a clamping protrusion and a valve seat. The clamping protrusion is formed eccentrically on and protrudes from the external surface of the selector valve. The valve seat is formed on and protrudes upward from a top of the selector valve and has a valve hole selectively communicating with one of the passageways of the cylinder. The switching stem is movably mounted in the shell, is connected securely to the selector valve and has a clamping arm connected securely to the clamping protrusion of the selector valve.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pneumatic tool with a first embodiment of an air-inlet switching assembly in accordance with the present invention;

FIG. 2 is an exploded perspective view of the pneumatic tool with the air-inlet switching assembly in FIG. 1;

FIG. 2A is an enlarged perspective view of a cylinder of the pneumatic tool in FIG. 2;

FIG. 3 is an enlarged exploded perspective view of the air-inlet switching assembly in FIG. 2;

FIG. 4 is an operational side view in partial section of the air-inlet switching assembly in FIG. 1;

FIG. 5 is an operational top view of the air-inlet switching assembly in FIG. 4;

FIG. 6 is another operational top view of the air-inlet switching assembly in FIG. 4;

FIG. 7 is an enlarged exploded perspective view of a second embodiment of an air-inlet switching assembly in accordance with the present invention;

FIG. 8 is an operational side view in partial section of the air-inlet switching assembly in FIG. 7;

FIG. 9 is an operational top view of the air-inlet switching assembly in FIG. 8; and

FIG. 10 is another operational top view of the air-inlet switching assembly in FIG. 8.

### DETAILED DESCRIPTION OF THE PREFERRED EMBODIMENT

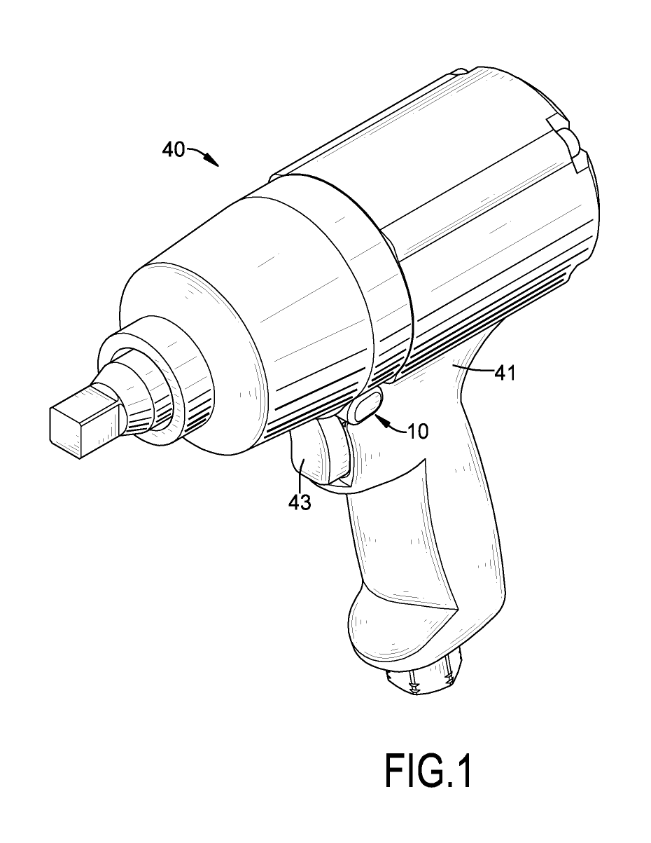

With reference to FIGS. 1 to 4, 7 and 8, an air-inlet switching assembly in accordance with the present invention for a pneumatic tool 40 having a gun shaped shell 41 and a cylinder 42 is mounted in the shell 41 below the cylinder 42 and comprises a switching stem 10 and a selector valve 20.

The shell 41 has a handle segment and a barrel segment. The handle segment of the shell 41 is hollow and has an inlet tube 411, an airtight valve 412 and a trigger 43. The inlet tube 411 is formed in the handle segment of the shell 41 and has an inner end and an outer end to allow the compressed air to flow into the inlet tube 411 from the outer end to the inner end of the inlet tube 411. The airtight valve 412 is mounted in the inlet tube 411 to stop the flow of the compressor air and has a central rod. The trigger 43 is pressably connected to the handle segment of the shell 41 and has a pressing rod extending into the inlet tube 411 and connected to the central rod of the airtight valve 412. The barrel segment of the shell 41 is hollow and is formed with the handle segment of the shell 41 above the inlet tube 411 and the trigger 43.

The cylinder 42 is mounted securely in the barrel segment of the shell 41 and has an annular sidewall, a forward passageway 421, a reverse passageway 422 and a rotor 423. The forward passageways 421, 422 are separately formed through the annular sidewall of the cylinder 42 and communicate with the inlet tube 411 of the shell 41.

The selector valve 20 is hollow, is rotatably mounted in the inlet tube 411 of the shell 41 between the cylinder 42 and the pressing rod of the trigger 43 and selectively communicates one of the passageways 421, 422 of the cylinder 42 and has a top, a middle, an external surface, a clamping protrusion 21, a valve seat 22 and a release space 23. The clamping protrusion 21 is formed eccentrically on and protrudes from the external surface of the selector valve 20 at the middle of the selector valve 20. The valve seat 22 may be fan shaped, is formed on and protrudes upward from the top of the selector valve 20 and has a top surface and a valve hole 221. The valve hole 221 is formed through the top surface of the valve seat 22, communicates with the inlet hole 411 of the shell 41 and selectively communicates with one of the passageways 421, 422 of the cylinder 42. The release space 23 is defined in the top of the selector valve 20 between the valve seat 22, the shell 41 and the cylinder 42.

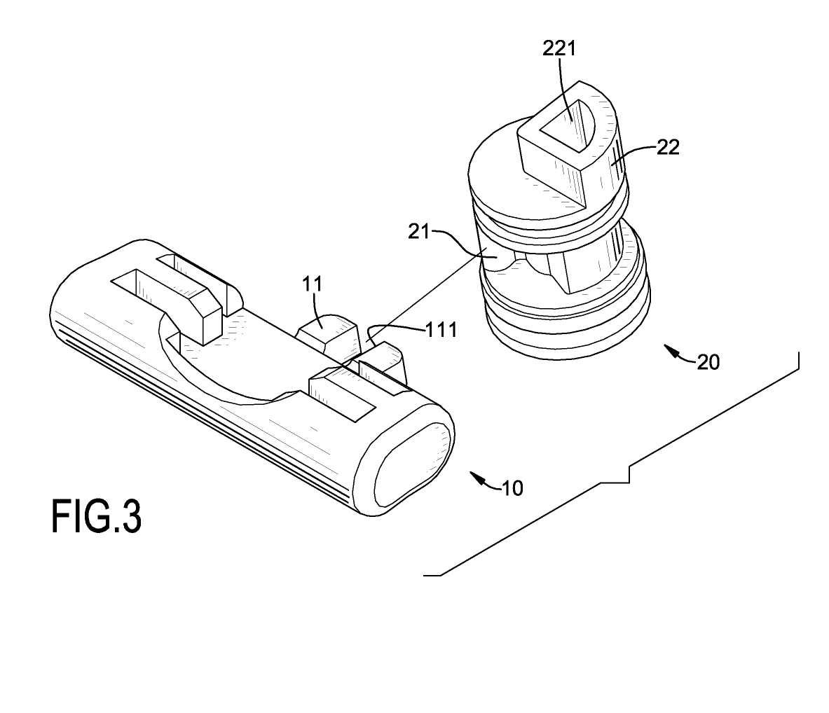

The switching stem 10 is movably mounted in the handle segment of the shell 41 below the barrel segment of the shell 41, is connected securely to the selector valve 20 and has a middle, a bottom, a rear side and a clamping arm 11, 11A. With reference to FIG. 3, the clamping arm 11 is formed on and protrudes form the rear side of the switching stem 10 at the middle of the switching stem 10, is connected securely to the clamping protrusion 21 of the selector valve 20 and has a free end and a clamping hole 111. The clamping hole 111 is formed through the free end of the clamping arm 11 opposite to the rear side of the switching stem 10 and is connected securely to the clamping protrusion 21 of the selector valve 20.

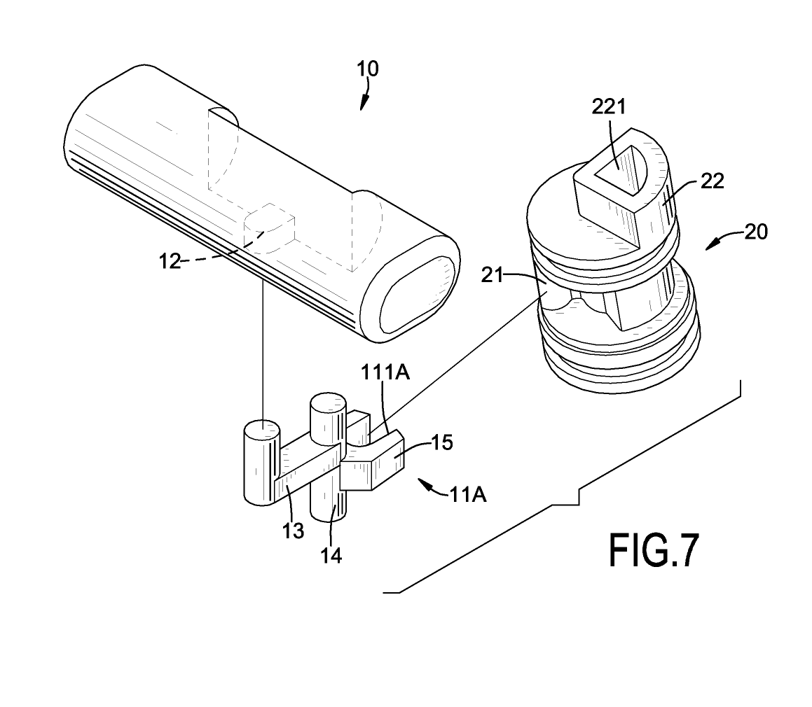

With reference to FIG. 7, the switching stem 10 further has a mounting hole 12 formed in the bottom of the switching stem 10 at the middle and the clamping arm 11A is detachably connected to the mounting hole 12 of the switching stem 10 and has a front end, a middle, a rear end, a mounting rod 13, a linking rod 14, a connecting rod 15 and a clamping hole 111A. The mounting rod 13 is formed on and protrudes upward from the front end of the clamping arm 11A and is mounted in the mounting hole 12 of the switching stem 10. The linking rod 14 is formed on and protrudes from the middle of the clamping arm 11A, is parallel to the mounting rod 13 and has an outer surface. The connecting rod 15 is formed on and protrudes from the outer surface of the linking rod 14 opposite to the mounting rod 13 and has a free end. The clamping hole 111A is formed through the free end of the connecting rod 15 and is connected securely to the clamping protrusion 21 of the selector valve 20.

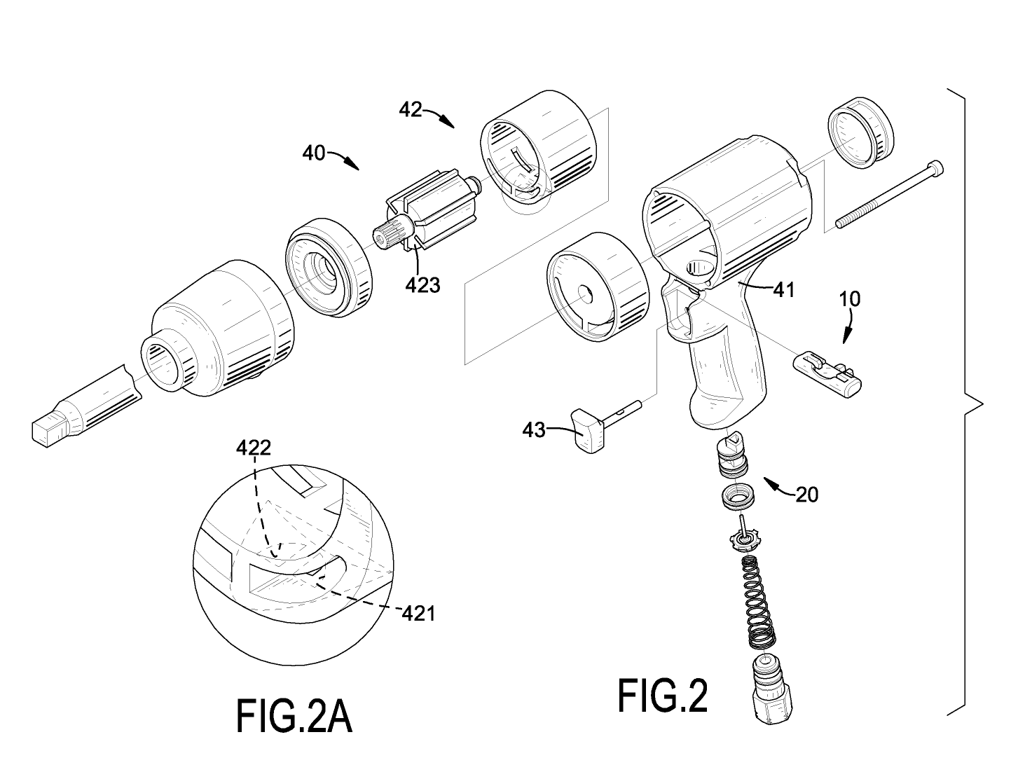

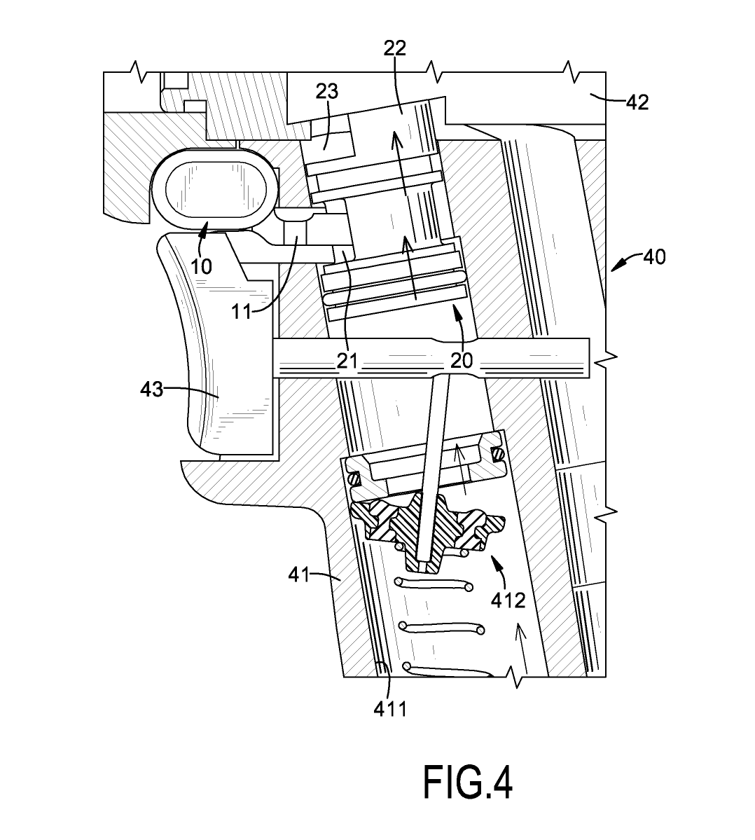

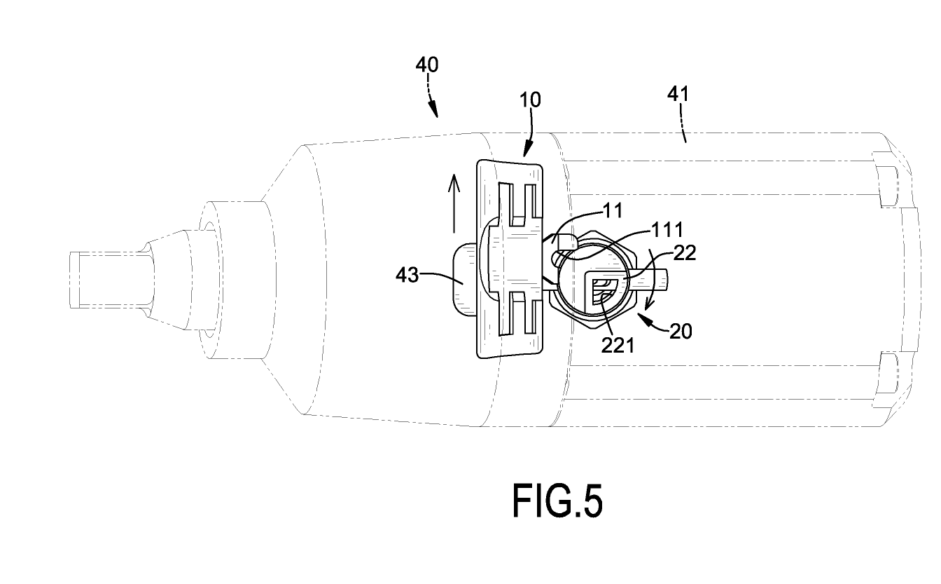

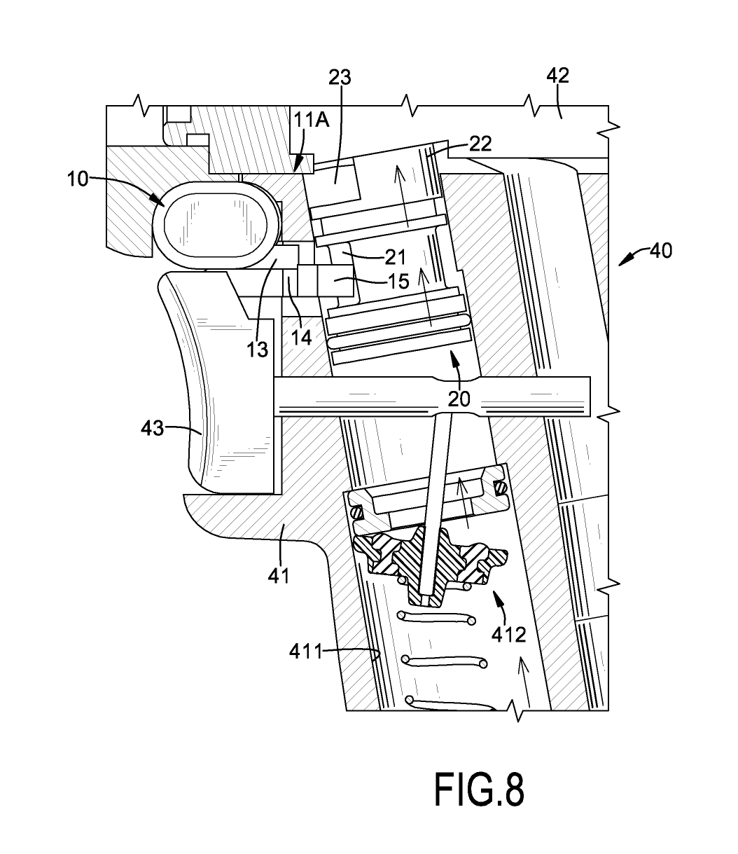

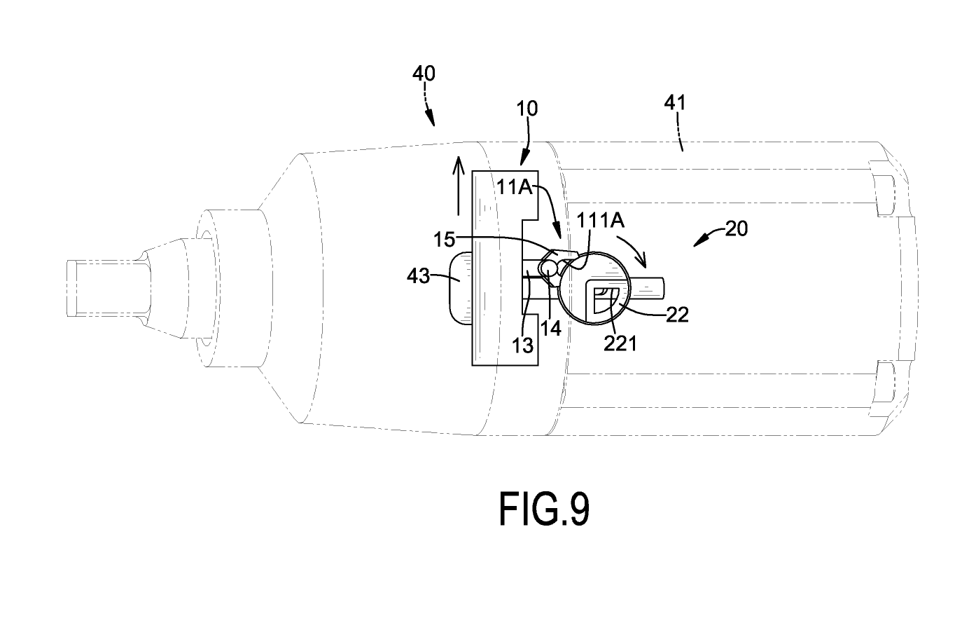

With reference to FIGS. 2A, 5 and 9, when a user wants to fasten a bolt or a nut, the switching stem 10 is pushed to move relative to the shell 41 by the user's thumb (if the user's right hand holds the shell 41) to communicate the valve hole 221 of the valve seat 22 with the forward passageway 421 of the cylinder 42 and the trigger 43 is then pressed to decline the airtight valve 412 relative to the inlet tube 411. Consequently, the compressed air will flow into the cylinder 42 via the inlet tube 411, the airtight valve 412, the valve hole 221 and the forward passageway 421 as shown in FIGS. 4 and 8. The compressed air that flows into the cylinder 42 can be used to drive the rotor 423 to rotate in a forward direction to enable the pneumatic tool to fasten bolts or nuts.

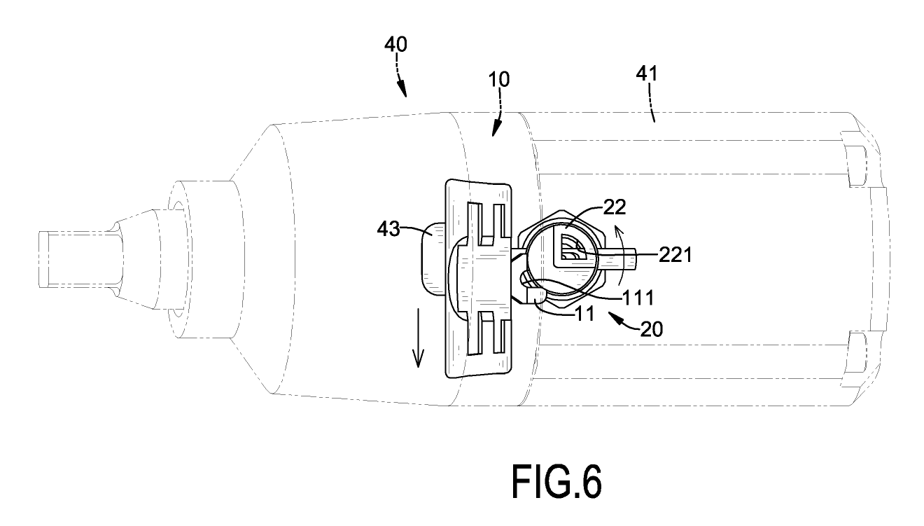

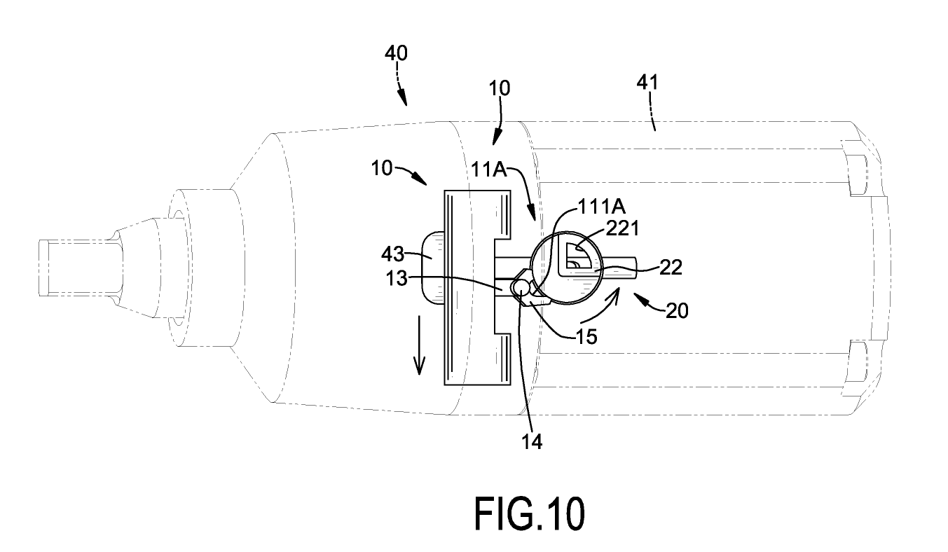

With reference to FIGS. 6 and 10, when a user wants to loosen a bolt or a nut, the switching stem 10 is pushed to move relative to the shell 41 by the user's forefinger (if the user's right hand holds the shell 41) to communicate the valve hole 221 of the valve seat 22 with the reverse passageway 422 of the cylinder 42 and the trigger 43 is then pressed to decline the airtight valve 412 relative to the inlet tube 411. Consequently, the compressed air will flow into the cylinder 42 via the inlet tube 411, the airtight valve 412, the valve hole 221 and the reverse passageway 422. The compressed air that flows into the cylinder 42 can be used to drive the rotor 423 to rotate in a reverse direction to enable the pneumatic tool to loosen bolts or nuts. Consequently, the flow direction of the compressed air can be changed with pushing the switching stem 10 in opposite directions for fastening or loosening bolts or nuts.

According to the above mentioned, the user can change the rotating direction of the rotor 423 to fasten or loosen bolts or nuts only by one finger pushing the switching stem 10 to move relative to the shell 41 in opposite directions and this is convenient in use. In addition, with the simplified structure and the engagement between the switching stem 10 and the selector valve 20 of the air-inlet switching assembly in accordance with the present invention, the cost for manufacturing an air-inlet switching assembly can be reduced, and the air-inlet switching assembly can be assembled and maintained conveniently.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An air-inlet switching assembly for a pneumatic tool having a gun shaped shell with an inlet tube and a cylinder with a forward passageway and a reverse passageway, and the air-inlet switching assembly comprising
a selector valve being hollow, being adapted to be rotatably mount in the inlet tube of the shell below the cylinder to selectively communicate one of the passageways of the cylinder and having
a top;
a middle;
an external surface;
a clamping protrusion formed eccentrically on and protruding from the external surface of the selector valve at the middle of the selector valve; and
a valve seat formed on and protruding upward from the top of the selector valve and having
a top surface; and
a valve hole formed through the top surface of the valve seat to communicate with the inlet hole of the shell and to selectively communicate with one of the passageways of the cylinder; and
a switching stem connected securely to the selector valve to be movably mounted in the shell and having
a middle;
a bottom;
a rear side; and
a clamping arm mounted on the rear side of the switching stem at the middle of the switching stem, connected securely to the clamping protrusion of the selector valve and having
a free end extending opposite to the rear side of the switching stem; and
a clamping hole formed through the free end of the clamping arm and connected securely to the clamping protrusion of the selector valve.

2. The air-inlet switching assembly for a pneumatic tool as claimed in claim 1, wherein the clamping arm is formed on and protrudes form the rear side of the switching stem at the middle of the switching stem.

3. The air-inlet switching assembly for a pneumatic tool as claimed in claim 1, wherein
the switching stem has a mounting hole formed in the bottom of the switching stem at the middle; and
the clamping arm is detachably connected to the mounting hole of the switching stem.

4. The air-inlet switching assembly for a pneumatic tool as claimed in claim 3, wherein
the clamping arm has
a front end;
a middle;
a rear end;
a mounting rod formed on and protruding upward from the front end of the clamping arm and mounted in the mounting hole of the switching stem;
a linking rod formed on and protruding from the middle of the clamping arm, parallel the mounting rod and having an outer surface; and
a connecting rod formed on and protruding from the outer surface of the linking rod opposite to the mounting rod and having a free end; and
the clamping hole of the clamping arm is formed through the free end of the connecting rod and is connected securely to the clamping protrusion of the selector valve.

5. The air-inlet switching assembly for a pneumatic tool as claimed in claim 2, wherein the selector valve has a release space formed in the top of the selector valve to be mounted between the valve seat, the shell and the cylinder of the pneumatic tool.

6. The air-inlet switching assembly for a pneumatic tool as claimed in claim 3, wherein the selector valve has a release space formed in the top of the selector valve to be mounted between the valve seat, the shell and the cylinder of the pneumatic tool.

7. The air-inlet switching assembly for a pneumatic tool as claimed in claim 4, wherein the selector valve has a release space formed in the top of the selector valve to be mounted between the valve seat, the shell and the cylinder of the pneumatic tool.

8. The air-inlet switching assembly for a pneumatic tool as claimed in claim 5, wherein the valve seat is fan shaped.

9. The air-inlet switching assembly for a pneumatic tool as claimed in claim 6, wherein the valve seat is fan shaped.

10. The air-inlet switching assembly for a pneumatic tool as claimed in claim 7, wherein the valve seat is fan shaped.
